(19) United States
(12) Patent Application Publication
(10) Pub. No.: US 2009/0136761 A1
(43) Pub. Date: May 28, 2009

(54) METHOD FOR MANUFACTURING SPACER OF FIELD EMITTERS AND BASE MATERIAL UTILIZED FOR THE SPACER

(75) Inventors: Ming-Chung Fan, Taipei (TW); Chi-Tsung Lo, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: TATUNG CO., LTD., Taipei (TW)

(21) Appl. No.: 11/737,130

(22) Filed: Apr. 18, 2007

(30) Foreign Application Priority Data
Jan. 8, 2007 (TW) 096100700

(51) Int. Cl. B32B 17/00; B32B 9/00; B32B 15/00; B32B 13/00; B44C 1/22

(52) U.S. Cl. 428/426; 428/411.1; 428/457; 428/688; 428/702; 428/446; 216/41

(57) ABSTRACT

A method for manufacturing a spacer of field emission display panel comprises the following steps: first, providing a substrate; forming a colloid on the substrate; then, forming a patterned photoresist layer on the colloid of the substrate; making the colloid with a pattern the same as the patterned photoresist layer; subsequently, removing the patterned photoresist layer, and hardening the colloid on the substrate; and finally, removing the substrate. The present invention also discloses a base material utilized for the spacer, resulting in a low manufacturing cost of the spacer and achieving economic benefits of large product quantity.

### BACKGROUND OF THE INVENTION

1. Field of the Invention

The present invention relates to a method for manufacturing a spacer of field emitters and a base material utilized for the spacer, and particularly to a method for manufacturing a spacer of field emission display panel adapted for a field emission display device and a base material utilized for the spacer.

2. Description of Related Art

Currently, display devices are more and more important for daily life. In addition to computers and the Internet, TVs, cell phones, personal digital assistants (PDAs), and vehicle information systems, etc., also need to be controlled to transmit signals by display devices. Based on factors of weight, volume, and health, the frequency for people to use flat panel display devices is higher and higher. Among many novel technologies of display devices, field emission display devices (FEDs), which have a characteristic of high definition of picture tubes, are better than traditional liquid crystal display devices which have shortcomings of small visual angles, small range of use temperature, and low reactive speed. The FEDs have advantages of a higher product yield, a higher reactive speed, a better quality of display coordination, a brightness over 100 ftL, light and thin structures, a larger range of color temperature, a higher mobile efficiency, an easy recognition of tilt direction, and so forth. In addition, because FEDs are luminous flat panel display devices of which high efficient fluorescent membranes are used in the structure, they can perform with excellent brightness even under outdoor sunlight. Therefore, they are regarded as a novel technology to compete with or even replace with LCDs.

The principle of luminance for FEDs is to emit, under a 10⁻⁶ torr vacuum, electrons from a cathode plate in an electric field. In acceleration of the positive voltage of an anode plate, the electrons emitted from the cathode plate bombard fluorescent powders on the anode plate, hence the fluorescent powders luminesce. Besides, the strength of the electric field will affect the amount of electrons emitted from the cathode. In other words, the stronger the electric field is, the more electrons will be emitted from the cathode. Moreover, since gates of the FEDs are formed in a circular shape, when an uneven electric field is provided, a circular distribution of the electrons emitted from the cathode becomes uneven. This will cause FEDs to have an uneven brightness, and hence result in a poor quality of FEDs' display picture.

Furthermore, except for the cathode and the anode, the FEDs further comprise a spacer to maintain a space between the cathode and the anode. Conventional FEDs' spacers have a large aspect ratio so as to reduce the display area occupied by the spacers. However, the FEDs' spacers with a large aspect ratio have difficulties in manufacture, let alone the spacers are tilted easily. In addition, some conventional spacers are made through mold processing or laser processing. The spacers made by the above methods are too expensive to achieve economic benefits. Other spacers are formed by way of carborundum sandblasting, but the facility therefor is also very expensive, so the yield of the products cannot be improved.

To overcome the aforementioned shortcomings, the present invention provides a method for manufacturing a spacer of field emission display panel.

### SUMMARY OF THE INVENTION

An object of the present invention is to provide a method for manufacturing a spacer of field emission display panel, where the method comprises the following steps: first, providing a substrate; forming a colloid on the substrate; then, forming a patterned photoresist layer on the colloid of the substrate; making the colloid with a pattern the same as the patterned photoresist layer; subsequently, removing the patterned photoresist layer, and hardening the colloid on the substrate; and finally, removing the substrate. Hence, the spacer utilized in a field emission display panel is completed.

In the method for manufacturing the spacer of the field emission display panel according to the present invention, material of the substrate is not limited to be of any kind, but preferably a material with good rigidity and the substrate is of flat surfaces. For example, the material of the substrate may be selected from the group consisting of glass, metal, and ceramics. In addition, a release agent can be spread on the substrate, and the colloid is formed on the release agent. The substrate is removed by way of removing the release agent. Material of the release agent can be selected from the group consisting of graphite, ceramic powders, an emulsifier, a hydrophilic solvent, and a combination thereof.

In the present invention, a method for forming the colloid on the substrate is selected from the group consisting of screen-printing, spatula-printing, and spraying. The colloid can be of any paste, but preferably of glass cement. Besides, material of the glass cement is selected from the group consisting of lead oxide, boron oxide, zinc oxide, silica, sodium oxide, alumina, calcium oxide, and a combination thereof.

The patterned photoresist layer formed on the colloid in the present invention can be made of any material as long as is a photosensitive material, but is preferably made of a dry film.

In the present invention, after forming the colloid on the substrate, the colloid is heated, and then the patterned photoresist layer is formed on the colloid of the substrate. The colloid is heated at a temperature in accordance with the material of the colloid, but preferably at a temperature ranging from 80° C. to 150° C. Herein, the purpose of heating the colloid is to make the colloid firm enough for forming subsequently the patterned photoresist layer thereon, but the colloid is not totally hardened.

In the present invention, after forming the patterned photoresist layer on the colloid of the substrate, the colloid with a pattern the same as the patterned photoresist layer is formed through etching or sandblasting, but is preferably formed by way of sandblasting.

In the step of hardening the colloid on the substrate according to the present invention is processed through heating, and is preferably processed through heating at a temperature ranging from 350° C. to 600° C.

Another object of the present invention is to provide a base material utilized for the spacer, where the base material comprises a substrate and a colloid, and where a release agent is formed on the substrate. Besides, the colloid is located on the release agent of the substrate.

In the base material utilized for the spacer according to the present invention, the substrate can be made of any material that has characteristics of good rigidity and can be of flat surfaces. For example, the substrate can be made of a material selected from the group consisting of glass, metal, and ceramics. The colloid can be of any paste, but preferably be of glass cement. Besides, material of the glass cement is selected from the group consisting of lead oxide, boron oxide, zinc oxide, silica, sodium oxide, alumina, calcium oxide, and a combination thereof. The release agent on the substrate is made of a material selected from the group consisting of graphite, ceramic powders, an emulsifier, a hydrophilic solvent, and a combination thereof.

Therefore, using the method and the base material according to the present invention can reduce the cost of manufacturing the spacer and improve the quality of products. Also, the method and the base material according to the present invention can be applied to satisfy various requirements, e.g. in a field emission display panel or a back light module.

Other objects, advantages, and novel features of the invention will become more apparent from the following detailed description when taken in conjunction with the accompanying drawings.

### BRIEF DESCRIPTION OF THE DRAWINGS

FIGS. 1A to 1F are cross-sectional views showing a sequence in manufacturing a spacer of field emission display panel according to the present invention;

FIG. 2 is a partial perspective view of the spacer of the field emission display panel according to the present invention; and

FIG. 3 is a cross-sectional view of the spacer utilized in a field emitting display device according to the present invention.

### DETAILED DESCRIPTION OF THE PREFERRED EMBODIMENT

By the following specific embodiments, the present invention is put into practice. One skilled in the art can easily understand other advantages and efficiency of the present invention through the disclosed content of the specification. Through other different embodiments, if any, the present invention can also be carried out or applied. In accordance with different observations and applications, all details of the specification can be modified and changed as not going against the spirit of the present invention.

The drawings, illustrated as aforementioned, are all simplified charts or views, and only reveal elements relative to the present invention. The elements revealed in the drawings are not substantial aspects in practice. In addition, the quantity and the shape of the substantial elements in practice can also be optionally designed. Furthermore, the layout of the elements for implementation can be more complex than that of the present invention.

### Embodiment 1

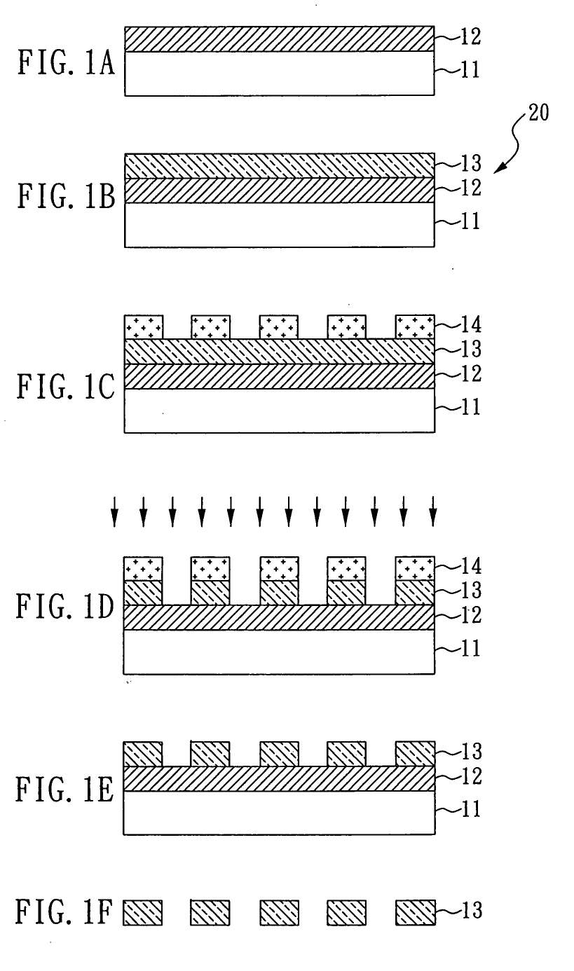

As shown in FIG. 1A, a substrate 11 is provided. The substrate 11 is made of a material with characteristics of good rigidity and that the substrate 11 is of flat surfaces. In the present embodiment, the substrate 11 is made of glass. A release agent 12 is spread on the substrate 11. The material of the release agent 12 is selected from the group consisting of graphite, ceramic powders, an emulsifier, and a hydrophilic solvent. Then, as shown in FIG. 1B, glass cement 13 is formed on the release agent 12 of the substrate 11, by way of screen-printing. The main material of the glass cement 13 is silica. The thickness of the glass cement 13 is about 0.7 mm. In addition, the glass cement 13 is in a state of paste. Furthermore, the substrate 11 having the glass cement 13 thereon is processed with heating at a temperature ranging from 80° C. to 150° C. The purpose of the heating process is to make the glass cement 13 slightly hardened but not totally hardened. Herein, the substrate 11 having the glass cement 13 thereon acts as a base material 20. After the base material 20 is processed with the following processes, the glass cement 13 is utilized as a spacer. In the present embodiment, the glass cement 13 is applied to be a spacer of a field emission display panel.

Subsequently, as shown in FIG. 1C, a photoresist layer 14 made as a dry film is formed on the slightly hardened glass cement 13. The photoresist layer 14 is patterned by way of a lithography process, namely by way of exposure and development.

Then, as shown in FIG. 1D, after patterning of the photoresist layer 14, a part of the glass cement 13, not covered with the patterned photoresist layer 14, is removed by way of sandblasting, while another part of the glass cement 13, covered with the patterned photoresist layer 14, is maintained. Thus, patterned glass cement 13 is obtained.

Further, as shown in FIG. 1E, the patterned photoresist layer 14 is removed. The patterned glass cement 13 is heated to become hardened at a temperature ranging from 350° C. to 600° C. The purpose of heating the patterned glass cement 13 is to obtain thoroughly hardened patterned glass cement 13.

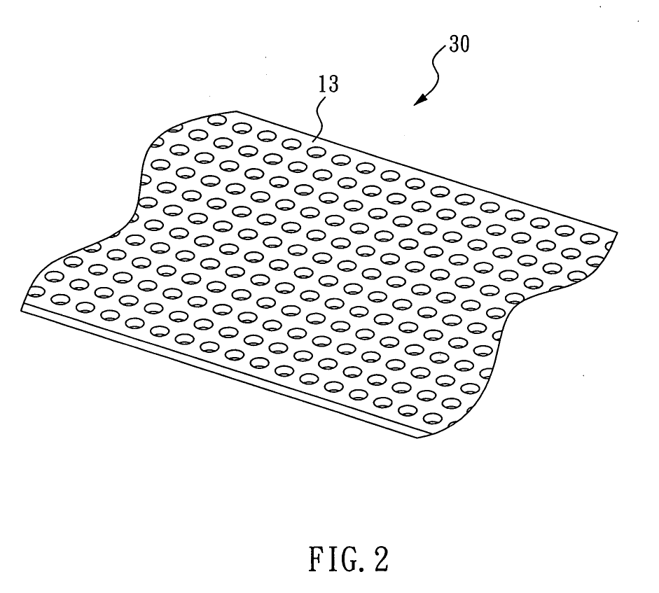

Finally, as shown in FIG. 1F, the substrate 11 is removed from the patterned glass cement 13 by means of the release agent 12. The thickness of the patterned glass cement 13, as a spacer, is about 0.5 mm. With reference to FIG. 2, the thoroughly hardened patterned glass cement 13 acts as a spacer 30 of field emission display panel, which is a flat spacer. The patterned glass cement 13 shown in FIG. 1F is just a cutaway view of one part of the spacer 30 shown in FIG. 2.

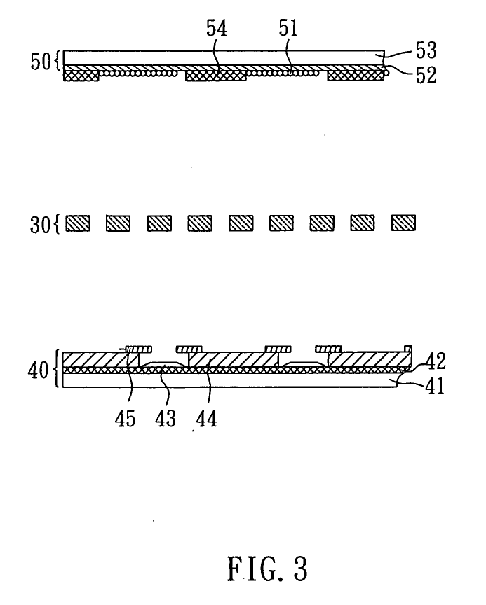

With reference to FIG. 3, a breakdown drawing of the spacer utilized in a field emitting display device in the preferred embodiment according to the present invention, wherein the field emitting display device comprises a cathode plate 40, an anode plate 50, and the spacer 30 located therebetween. When the aforementioned spacer 30 is completed, it is packaged with the cathode plate 40 and the anode plate 50.

The structure of the cathode plate 40 and the anode plate 50 is further illustrated hereinafter. The cathode plate 40 comprises a substrate 41, a cathode 42, cathode electron emitters 43, a first insulation layer 44, and a gate 45. The cathode 42 is located on the substrate 41. The cathode electron emitters 43 are arranged on a suitable site of the cathode 42. The cathode electron emitters 43 are made of cathode electron emitting material, such as carbon nanotubes, for the purpose of providing electrons required for controlling luminescence of the field emission display panel. Therefore, through controlling variations of the voltage difference between the cathode 42 and the gate 45, every cathode electron emitter 43 can emit electrons at a designated timing. Moreover, the anode plate 50 comprises a luminant layer 51, a mask layer 54, an anode 52, and a transparent panel 53. The anode 52 is made of transparent conductive material, e.g. indium tin oxide (ITO). The luminant layer 51 and the mask layer 54 are under the anode 52. The luminant layer 51 is made of luminant material emitting fluorescence or others. The transparent panel 53, made of glass or other transparent material, is located on the anode 52.

The flat spacer 30 according to the present invention can maintain a spacing between the cathode plate 40 and the anode plate 50, and can prevent electrons emitting deviatingly from the cathode plate 40.

### Embodiment 2

The present embodiment is similar to Embodiment 1, except for the substrate 11 which in the present embodiment is made of metal (see FIG. 1A).

### Embodiment 3

The present embodiment is similar to Embodiment 1, except for the substrate 11 which in the present embodiment is made of ceramics (see FIG. 1A).

### Embodiment 4

The present embodiment is similar to Embodiment 1, except for a formation of the glass cement 13 which in the present embodiment is formed on the release agent 12 of the substrate 11, by way of spatula printing (see FIG. 1B).

### Embodiment 5

The present embodiment is similar to Embodiment 1, except for a formation of the glass cement 13 which in the present embodiment is formed on the release agent 12 of the substrate 11, by way of spraying (see FIG. 1B).

### Embodiment 6˜11

Embodiments 6˜11 are similar to Embodiment 1, except for materials of the glass cement 13 (see FIG. 1B), as shown in Table 1.

TABLE 1

| Embodiment | 6 | 7 | 8 | 9 | 10 | 11 |
|---|---|---|---|---|---|---|
| Material | Lead | Boron | Zinc | Sodium | Alumina | Calcium |
| | oxide | oxide | oxide | oxide | | oxide |

### Embodiment 12

The present embodiment is similar to Embodiment 1, except for the way of removing the glass cement 13 uncovered with the photoresist layer 14 which in the present embodiment is removed by way of etching (see FIG. 1D).

In conclusion, the method for manufacturing the spacer of the field emission display panel according to the present invention is different from a conventional mold processing, laser processing, or carborundum sandblasting. In the present invention, the glass cement is formed by way of screen printing, spatula printing, or spraying on the substrate, and then the glass cement is covered with the patterned photoresist layer so as to form the patterned glass cement by way of sandblasting or etching. In addition, the release agent formed on the substrate facilitates removing of the substrate from the spacer made of the glass cement. Therefore, as mentioned above, the cost of products can be extremely reduced so as to achieve economic benefits of large product quantity, through the method of the present invention.

Although the present invention has been explained in relation to its preferred embodiments, it is to be understood that many other possible modifications and variations can be made without departing from the scope of the invention as hereinafter claimed.

What is claimed is:

1. A method for manufacturing a spacer of field emission display panel, comprising the following steps:
providing a substrate;
forming a colloid on the substrate;
forming a patterned photoresist layer on the colloid of the substrate;
making the colloid with a pattern the same as the patterned photoresist layer;
removing the patterned photoresist layer, and hardening the colloid on the substrate; and
removing the substrate.

2. The method as claimed in claim 1, wherein the material of the substrate is selected from the group consisting of glass, metal, and ceramics.

3. The method as claimed in claim 1, wherein a release agent is spread on the substrate, and the colloid is formed on the release agent.

4. The method as claimed in claim 3, wherein the step of removing the substrate is processed through removing the release agent.

5. The method as claimed in claim 3, wherein the release agent is selected from the group consisting of graphite, ceramic powders, an emulsifier, a hydrophilic solvent, and a combination thereof.

6. The method as claimed in claim 1, wherein the method for forming the colloid on the substrate is selected from the group consisting of screen-printing, spatula-printing, and spraying.

7. The method as claimed in claim 1, wherein the colloid is glass cement.

8. The method as claimed in claim 7, wherein the material of the glass cement is selected from the group consisting of lead oxide, boron oxide, zinc oxide, silica, sodium oxide, alumina, calcium oxide, and a combination thereof.

9. The method as claimed in claim 1, wherein the patterned photoresist layer is a dry film.

10. The method as claimed in claim 1, wherein, after forming the colloid on the substrate, the colloid is heated before forming the patterned photoresist layer on the colloid of the substrate.

11. The method as claimed in claim 10, wherein the colloid is heated at a temperature ranging from 80° C. to 150° C.

12. The method as claimed in claim 1, wherein, after forming the patterned photoresist layer on the colloid of the substrate, the colloid with the pattern the same as the patterned photoresist layer is formed through etching or sandblasting.

13. The method as claimed in claim 12, wherein the colloid with the pattern the same as the patterned photoresist layer is formed by way of sandblasting.

14. The method as claimed in claim 1, wherein the step of hardening the colloid on the substrate is processed through heating.

15. The method as claimed in claim 14, wherein the step of hardening the colloid on the substrate is processed through heating at a temperature ranging from 350° C. to 600° C.

16. A base material utilized for a spacer, comprising:
a substrate, on which a release agent is formed; and
a colloid, located on the release agent of the substrate.

17. The base material as claimed in claim 16, wherein the substrate is made of a material selected from the group consisting of glass, metal, and ceramics.

18. The base material as claimed in claim 16, wherein the release agent is made of a material selected from the group consisting of graphite, ceramic powders, an emulsifier, a hydrophilic solvent, and a combination thereof.

19. The base material as claimed in claim 16, wherein the colloid is glass cement.

20. The base material as claimed in claim 19, wherein the glass cement is of a material selected from the group consisting of lead oxide, boron oxide, zinc oxide, silica, sodium oxide, alumina, calcium oxide, and a combination thereof.
